(19) United States
(12) Patent Application Publication
(10) Pub. No.: US 2020/0220755 A1
(43) Pub. Date: Jul. 9, 2020

(54) TRANSMITTER, RECEIVER, TRANSMISSION METHOD, RECEPTION METHOD, AND COMMUNICATION METHOD

(71) Applicant: Panasonic Intellectual Property Corporation of America, Torrance, CA (US)

(72) Inventors: SHOTARO MAKI, Tokyo (JP); HIDETOSHI SUZUKI, Kanagawa (JP)

(21) Appl. No.: 16/631,174

(22) PCT Filed: Jun. 28, 2018
(86) PCT No.: PCT/JP2018/024539

§ 371 Date: Jan. 15, 2020

(30) Foreign Application Priority Data
Aug. 10, 2017 (JP) 2017-155504

(51) Int. Cl. H04L 27/26; H04L 5/00; H04L 27/144

(52) U.S. Cl. CPC H04L 27/2613; H04L 27/144; H04L 27/2691; H04L 5/0048

(57) ABSTRACT

In a base station, an assignment circuit maps a phase tracking reference signal onto a subset of antenna ports of antenna ports each included in at least one group into which a plurality of antenna ports have been grouped. The group is determined on the basis of a measured value of phase noise measured for each of the plurality of antenna ports. A transmitting unit transmits a data signal and the phase tracking reference signal.

### TECHNICAL FIELD

The present disclosure relates to a transmitter, a receiver, a transmission method, a reception method, and a communication method.

### BACKGROUND ART

A communication system called “fifth-generation mobile communication system (5G)” has been under consideration. In 5G, flexible provision of a function to each of various use cases where an increase in communication traffic, an increase in the number of terminals to be connected, high reliability, low latency, and the like are needed has been under consideration. There are three typical use cases: enhanced Mobile Broadband (eMBB), Massive Machin Type Communications (mMTC), and Ultra Reliable and Low Latency Communications (URLLC). In 3GPP (3rd Generation Partnership Project), which is an international standardization organization, sophistication of communication systems has been under consideration from the embodiment of both sophistication of LTE systems and New RAT (Radio Access Technology) (see, for example, NPL 1).

### CITATION LIST

### Non Patent Literature

NPL 1: RP-161596, “Revision of SI: Study on New Radio Access Technology”, NTT DOCOMO, September 2016

NPL 2: R1-1612335, “On phase noise effects”, Ericsson, November 2016

NPL 3: R1-1709939, “PT-RS for CP-OFDM”, Huawei, HiSilicon, June 2017

### SUMMARY OF INVENTION

In New RAT, signals of high frequencies of, for example, 6 GHz or higher are utilized as carrier waves. In particular, in a case where a high frequency band and a higher-order modulation multivalued number (modulation order) are used, error rate characteristics deteriorate due to a CPE (common-phase error) or ICI (inter-carrier interference) that occurs due to the phase noise of a local oscillator (see, for example, NPL 2). To address this problem, New RAT has given consideration to a receiver's performing a CPE correction or ICI correction (hereinafter sometimes referred to as “CPE/ICI correction”) by means of a phase tracking reference signal (PT-RS) in addition to performing channel equalization.

However, further consideration needs to be given to a method for determining the number of antenna ports (sometimes referred to as “PT-RS ports”) through which to transmit PT-RSs.

An embodiment of the present disclosure facilitates providing a transmitter, a receiver, a transmission method, a reception method, a communication method that make it possible to transmit PT-RSs through appropriate antenna ports.

According to an embodiment of the present disclosure, there is provided a transmitter including: an assignment circuit that maps a phase tracking reference signal onto a subset of antenna ports of antenna ports each included in at least one group into which a plurality of antenna ports have been grouped, the group being determined on the basis of a measured value of phase noise measured for each of the plurality of antenna ports; and a transmitting circuit that transmits a data signal and the phase tracking reference signal.

According to an embodiment of the present disclosure, there is provided a receiver including: a receiving circuit that receives a data signal and a phase tracking reference signal transmitted from a subset of antenna ports of antenna ports each included in at least one group into which a plurality of antenna ports of a transmitter have been grouped, the group being determined on the basis of a measured value of phase noise measured for each of the plurality of antenna ports; and a demodulating circuit that demodulates the data signal by using a phase noise estimate value estimated from the phase tracking reference signal, wherein the demodulating circuit uses, as a phase noise estimate value for other antenna ports included in the group excluding the subset of antenna ports, the phase noise estimate value for the subset of antenna ports.

According to an embodiment of the present disclosure, there is provided a transmission method including: mapping a phase tracking reference signal onto a subset of antenna ports of antenna ports each included in at least one group into which a plurality of antenna ports have been grouped, the group being determined on the basis of a measured value of phase noise measured for each of the plurality of antenna ports; and transmitting a data signal and the phase tracking reference signal.

According to an embodiment of the present disclosure, there is provided a reception method including: receiving a data signal and a phase tracking reference signal transmitted from a subset of antenna ports of antenna ports each included in at least one group into which a plurality of antenna ports of a transmitter have been grouped, the group being determined on the basis of a measured value of phase noise measured for each of the plurality of antenna ports; and demodulating the data signal by using a phase noise estimate value estimated from the phase tracking reference signal, wherein in demodulating the data signal, the phase noise estimate value for the subset of antenna ports is used as a phase noise estimate value for other antenna ports included in the group excluding the subset of antenna ports.

According to an embodiment of the present disclosure, there is provided a communication method including: measuring a measured value of phase noise for each of a plurality of antenna ports of a transmitter; grouping the plurality of antenna ports into at least one group on the basis of the measured value of phase noise; mapping a phase tracking reference signal onto a subset of antenna ports of antenna ports each included in the at least one group; transmitting a data signal and the phase tracking reference signal; receiving the data signal and the phase tracking reference signal transmitted from the subset of antenna ports included in the group; and demodulating the data signal by using a phase noise estimate value estimated from the phase tracking reference signal, wherein in demodulating the data signal, the phase noise estimate value for the subset of antenna ports is used as a phase noise estimate value for other antenna ports included in the group excluding the subset of antenna ports.

It should be noted that general or specific embodiments may be implemented as a system, a method, an integrated circuit, a computer program, a storage medium, or any selective combination of a method, an apparatus, an integrated circuit, a computer program, and a storage medium.

An embodiment of the present disclosure makes it possible to transmit PT-RSs through appropriate antenna ports.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 shows an example of mapping of DMRSs and PT-RSs in MIMO.

FIG. 2 shows a configuration of a part of a base station according to Embodiment 1.

FIG. 3 shows a configuration of a part of a mobile station according to Embodiment 1.

FIG. 4 shows a configuration of the base station according to Embodiment 1.

FIG. 5 shows a configuration of the mobile station according to Embodiment 1.

FIG. 6 shows a process of the base station and the mobile station according to Embodiment 1.

FIG. 7 shows examples of indication parameters according to Embodiment 1.

FIG. 8 shows a configuration of a mobile station according to Embodiment 2.

FIG. 9 shows a configuration of a base station according to Embodiment 2.

FIG. 10 shows a process of the base station and the mobile station according to Embodiment 2.

### DESCRIPTION OF EMBODIMENTS

Embodiments of the present disclosure are described in detail below with reference to the drawings.

When a signal is assigned to a higher frequency band or when a higher modulation multivalued number is used for a signal, CPE/ICI exerts a greater influence on error rate characteristics. Accordingly, as mentioned above, in a case where a high frequency band and a higher-order modulation multivalued number are used, a receiver's performing a CPE/ICI correction by means of a PT-RS in addition to performing channel equalization has been under consideration.

For tracking of CPE/ICI, which randomly fluctuates over time, PT-RSs are more densely mapped onto a time axis than channel estimating (demodulating) reference signals (DMRSs: demodulation reference signals). Specifically, it is assumed that PT-RSs are mapped at a density such as every symbol, every symbol out of two adjacent symbols, or every symbol out of four adjacent symbols. Further, since CPE/ICI has the characteristics of fluctuating little between subcarriers, PT-RSs are comparatively less densely mapped in a frequency domain. Specifically, it is assumed that PT-RSs are mapped at such a density as one (e.g. subcarrier) per RB (resource block), one per two adjacent RBs, or one per four adjacent RBs.

According to the agreements about PT-RSs in 3GPP RAN1#88, PT-RSs are used between a base station (BS, eNB, gNB) and a mobile station (terminal, UE) indicated from the base station by higher layer signaling (e.g. RRC (radio resource control) signaling). Further, it is assumed that the density of allocation of PT-RSs in the time domain and the frequency domain flexibly varies according to a modulation multivalued number, a bandwidth, or the like that is used between the base station and the mobile station.

Further, a method by which a mobile station determines the density of allocation of PT-RSs has been under consideration. One method is a method by which the density of allocation of PT-RSs is indicated by a PT-RS dedicated control signal (e.g. DCI (downlink control information). an RRC signal, or the like) from a base station (explicit indication). Another method is a method by which a correspondence relationship between the density of allocation of PT-RSs and a different parameter (e.g. a modulation multivalued number or a bandwidth) is determined in advance and the mobile station determines the density of allocation of PT-RSs with reference to the different parameter and its correspondence relationship, which are indicated by DCI during communication (implicit indication). It should be noted that there is a possibility that a method other than these methods might be used.

Meanwhile, DMRSs for use in channel estimation, whose channel characteristics greatly vary in a frequency domain and do not as greatly vary in a time domain as phase noise, are more densely mapped onto the frequency domain and less densely mapped onto the time domain than PT-RSs. Furthermore, in New RAT, for earlier timing of data demodulation, the introduction of front-loaded DMRSs, which are allocated at the front of slots, is assumed.

Further, the application of the same precoding to PT-RSs as antenna ports through which to transmit DMRSs (also sometimes referred to as “DMRS ports”) has been under consideration, and it is also conceivable that PT-RSs may be defined as part of DMRSs. In this case, DMRSs that are used as PT-RSs are more densely mapped in the time domain and less densely mapped in the frequency domain than other DMRSs. Further, reference signals that are used for correction of CPE/ICI that occurs due to phase noise may be called in a name different from “PT-RS”.

Further, in New RAT, it is assumed that MIMO (multiple-input and multiple-output) is used. That is, a base station and one or more mobile stations located within a cell constituted by the base station are capable of transmission and reception through a plurality of antenna ports corresponding to different beams (precodings) that use the same time and frequency resources.

Further, in New Radio, the use of a CF-OFDM (cyclic prefix-orthogonal frequency division multiplexing) scheme is assumed in a downlink (direction from a base station to a mobile station). Meanwhile, in an uplink (direction from a mobile station to a base station), both the CP-OFDM scheme and a DFT-S-OFDM (discrete Fourier transform-spread OFDM) scheme are under consideration, and for example, switching between communication schemes according to communication environment for use is assumed.

PT-RSs are transmitted and received between a base station and each mobile station located within a cell constituted by the base station. Note here that since a set (group) of antenna ports that share a local oscillator of a transmitter (in a downlink, a base station; in an uplink, a mobile station) may be equal in value of CPE/ICI. For this reason, if the antenna ports are substantially equal in CPE/ICI, PT-RSs are transmitted from the transmitter through any antenna port of this group and the CPE/ICI of the antenna port is estimated by a receiver (in a downlink, a mobile station; in an uplink, a base station), whereby the receiver can also estimate the CPE/ICIs of the remaining antenna ports within the group. Therefore, the number of antenna ports through which to transmit and receive data may be smaller than the number of antenna ports through which to transmit and receive PT-RSs.

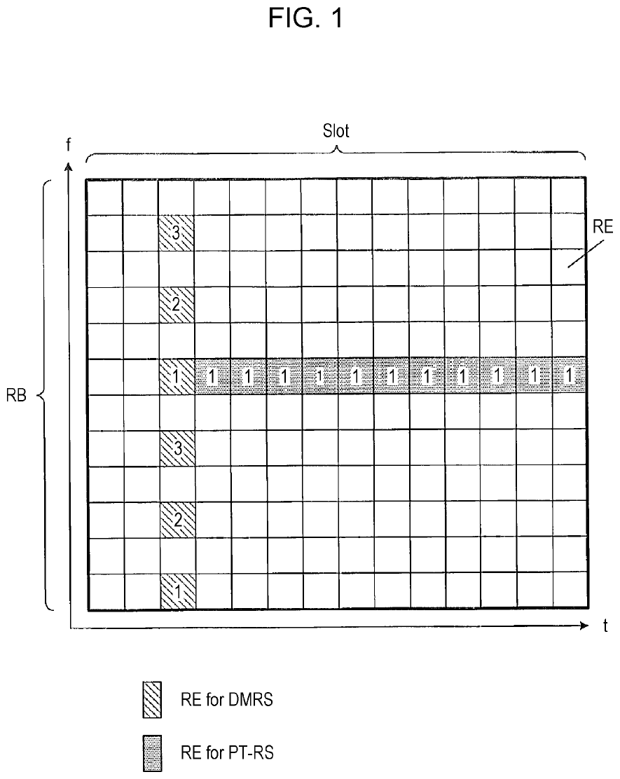

FIG. 1 shows an example of mapping of DMRSs and PT-RSs in MIMO under a CP-OFDM scheme. The numbers in the REs (resource elements) on which DMRSs and PT-RSs are mapped represent antenna port numbers. That is, DMRSs and PT-RSs of the same number in FIG. 1 share a precoding.

FIG. 1 assumes, as an example, that MIMO transmissions are made through three antenna ports (1 to 3) and the antenna ports are substantially equal in CPE/ICI. In FIG. 1, whereas DMRSs are mapped onto each separate antenna port, an PT-RS is mapped onto Antenna Port 1 out of Antenna Ports 1 to 3.

Note here that a method for determining the number of antenna ports (PT-RS ports) through which to transmit PT-RSs depending on the number of local oscillators mounted in a mobile station or a base station has been under consideration (see, for example, NPL 3).

However, how a CPE/ICI correction on a receiver side is affected by an actual difference in CPE/ICI in each local oscillator depends on the actual performance of the local oscillators to be mounted. That is, even in the case of a group of antenna ports in which signals are modulated by different local oscillators, there can be a case where it can be deemed, from the receiver's viewpoint, that these antenna ports are substantially equal in CPE/ICI. In this case, mapping a plurality of PT-RSs onto the respective antenna ports wastes resources.

Therefore, it is necessary that a set of antenna ports (number of antenna ports) of a transmitter that can be deemed to be equally affected by CPE/ICI (i.e. phase noise) from the viewpoint of a receiver (mobile station or base station) that receives PT-RSs be determined in consideration of the mounting of the transmitter and the receiver. That is, for the setting of PT-RS transmissions, further consideration needs to be given to how the “set of antenna ports” is defined and identified and how the number of antenna ports through which to transmit PT-RSs is determined.

Incidentally, unlike PT-RSs, DMRSs are highly likely to be mapped onto all antenna ports that are utilized for transmissions, respectively. A reason for this is that it is assumed that channel estimate values vary from antenna port to antenna port.

Accordingly, each embodiment of the present disclosure describes an antenna port PT-RS mapping method that makes it possible to appropriately determine the number of PT-RS transmission antenna ports and reduce PT-RS overhead.

[Quasi-Same Phase Noise Group]

In an embodiment of the present disclosure, in a case where it can be deemed, from a receiver's viewpoint, that the CPE/ICI of one antenna port is substantially equal to the CPE/ICI of another antenna port, a set (group) of these antenna ports which are substantially equal in CPE/ICI is called a “quasi-same phase noise group”. That is, the antenna ports included in a “quasi-same phase noise group” are configured as a group of antenna ports that are equal in CPE/ICI.

For example, the influence of phase noise (CPE/ICI) attributed to a local oscillator within a transmitter may be measured in advance by test equipment or the like (not illustrated). The measured value of the phase noise (CPE/ICI) from the receiver's viewpoint may depend, for example, on the circuit configuration of a mixer, a clock generation circuit, and the like or a technique for CPE/ICI correction at the receiver in addition to the local oscillator of the transmitter. The transmitter includes a plurality of antenna ports grouped into at least one quasi-same phase noise group on the basis of the measured value of the phase noise (CPE/ICI) thus measured. Note here that of the plurality of antenna ports of the transmitter, antenna ports that are equal in measured value of CPE/ICI belong to the same quasi-same phase noise group and antenna ports that are different in measured value of CPE/ICI from each other belong to different quasi-same phase noise groups, respectively.

Thus, an embodiment of the present disclosure introduces the concept “quasi-same phase noise group”.

### Embodiment 1

[Brief Overview of Communication System]

The present embodiment describes a downlink PT-RS mapping method.

A communication system according to the present embodiment includes a base station 100 (transmitter) and a mobile station 200 (receiver). For example, the base station 100 uses a high frequency band and a high-order modulation multivalued number.

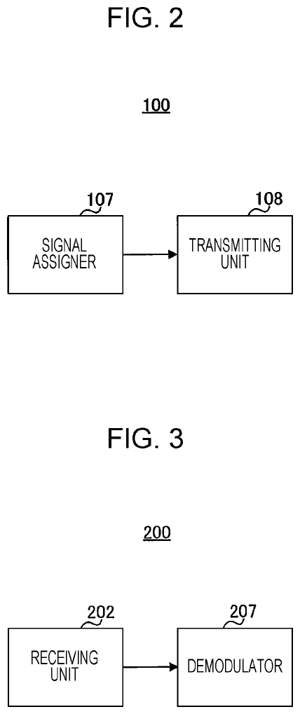

FIG. 2 is a block diagram showing a configuration of a part of the base station 100 according to the present embodiment. As shown in FIG. 2, the base station 100 includes a signal assigner 107 that maps a phase tracking reference signal (PT-RS) onto a subset of antenna ports of antenna ports each included in at least one group (quasi-same phase noise group) into which a plurality of antenna ports have been grouped. The quasi-same phase noise group is determined on the basis of a measured value of phase noise (CPE/ICI measured value) measured for each of the plurality of antenna ports. The base station 100 also includes a transmitting unit 108 that transmits a data signal and the phase tracking reference signal.

FIG. 3 is a block diagram showing a configuration of a part of the mobile station 200 according to the present embodiment. As shown in FIG. 3, the mobile station 200 includes a receiving unit 202 that receives a data signal and a phase tracking reference signal (PT-RS) transmitted from a subset of antenna ports of antenna ports each included in at least one group (quasi-same phase noise group) into which a plurality of antenna ports of a transmitter (base station 100) have been grouped. The quasi-same phase noise group is determined on the basis of a measured value of phase noise (CPE/ICI measured value) measured for each of the plurality of antenna ports. The mobile station 200 also includes a demodulator 207 that demodulates the data signal by using a phase noise estimate value estimated from the phase tracking reference signal. It should be noted that the demodulator 207 uses, as a phase noise estimate value for other antenna ports included in the group excluding the subset of antenna ports, the phase noise estimate value for the subset of antenna ports.

[Configuration of Base Station]

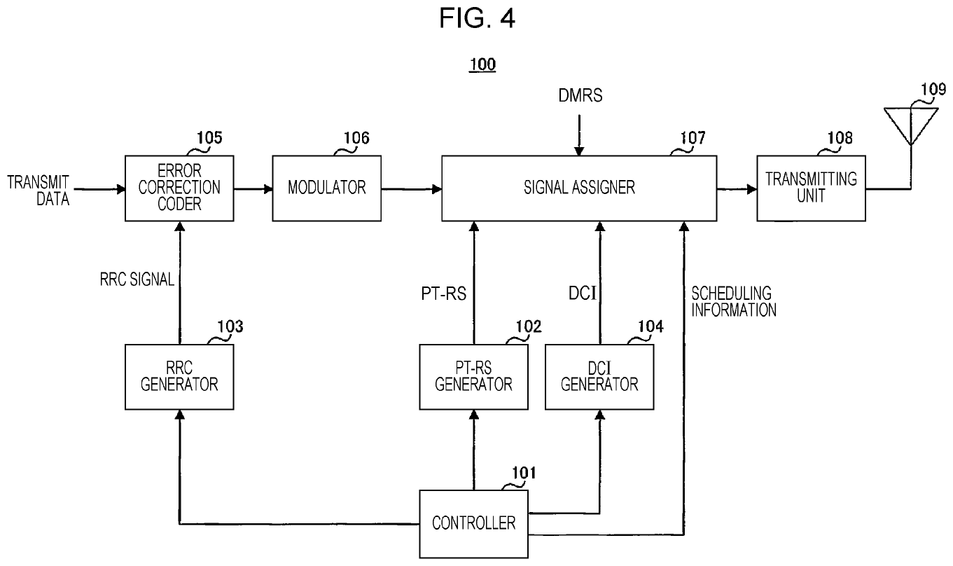

FIG. 4 is a block diagram showing a configuration of the base station 100 (transmitter) according to the present embodiment. As shown in FIG. 4, the base station 100 includes a controller 101, a PT-RS generator 102, an RRC generator 103, a DCI generator 104, an error correction coder 105, a modulator 106, the signal assigner 107, the transmitting unit 108, and an antenna 109.

The controller 101 outputs, to the RRC generator 103 and/or the DCI generator 104, information (quasi-same phase noise group related information) indicating which group of antenna ports of the antenna ports for use in transmission and reception is a quasi-same phase noise group.

Further, the controller 101 determines, on the basis of the quasi-same phase noise group related information, scheduling for an antenna port onto which to map a PT-RS. The controller 101 outputs, to the PT-RS generator 102 and the signal assigner 107, scheduling information containing information (PT-RS related information) related to the mapping of a PT-RS onto an antenna port. Alternatively, in a case where the PT-RS related information is indicated to the mobile station 200 by DCI, the controller 101 may output the scheduling information containing the PT-RS related information to the DCI generator 104.

The PT-RS generator 102 generates a PT-RS on the basis of the scheduling information inputted from the controller 101 and outputs the PT-RS thus generated to the signal assigner 107.

Upon receiving the quasi-same phase noise group related information from the controller 101, the RRC generator 103 generates an RRC signal containing the quasi-same phase noise group related information and outputs the RRC signal thus generated to the error correction coder 105.

Upon receiving the quasi-same phase noise group related information from the controller 101, the DCI generator 104 generates DCI containing the quasi-same phase noise group related information and outputs the DCI thus generated to the signal assigner 107. Alternatively, in a case where the PT-RS related information is indicated to the mobile station 200 by DCI, the DCI generator 104 may generate DCI containing the PT-RS related information received from the controller 101.

The error correction coder 105 subjects, to error correction coding, a transmit data signal inputted thereto or an RRC signal inputted thereto from the RRC generator 103 and outputs the signal subjected to the error correction coding to the modulator 106.

The modulator 106 performs a modulation process on the signal inputted from the error correction coder 105 and outputs the data signal thus modulated (which may contain an RRC signal) to the signal assigner 107.

The signal assigner 107 maps a DMRS, the data signal inputted from the modulator 106, and the PT-RS inputted from the PT-RS generator 102 or the DCI inputted from the DCI generator 104 onto time and frequency domains and outputs the signals thus mapped to the transmitting unit 108. In so doing, on the basis of the scheduling information inputted from the controller 101, the signal assigner 107 maps the PT-RS onto one of the antenna ports that belong to the quasi-same phase noise group.

The transmitting unit 108 subjects the signals inputted from the signal assigner 107 to a radio transmission process such as frequency conversion through carrier waves and outputs the signals subjected to the radio transmission process to the antenna 109.

The antenna 109 emits, toward the mobile station 200, the signals inputted from the transmitting unit 108.

[Configuration of Mobile Station]

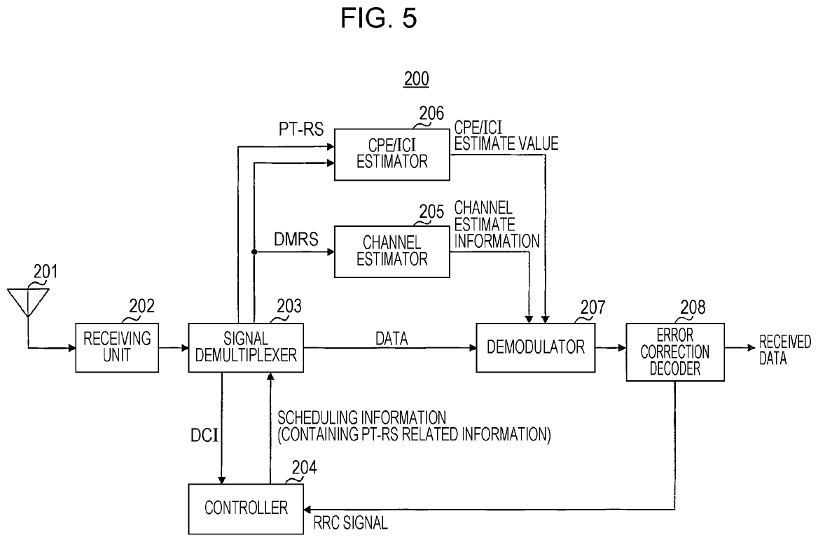

FIG. 5 is a block diagram showing a configuration of the mobile station 200 (receiver) according to the present embodiment. As shown in FIG. 5, the mobile station 200 includes an antenna 201, the receiving unit 202, a signal demultiplexer 203, a controller 204, a channel estimator 205, a CPE/ICI estimator 206, the demodulator 207, and an error correction decoder 208.

The antenna 201 receives signals transmitted from the base station 100 (see FIG. 4) and outputs the received signals to the receiving unit 202.

The receiving unit 202 subjects the received signals inputted from the antenna 201 to a radio reception process such as frequency conversion and outputs the signals subjected to the radio reception process to the signal demultiplexer 203.

The signal demultiplexer 203 demultiplexes the DCI from among the signals inputted from the receiving unit 202 first and then outputs the DCI to the controller 204. Then, on the basis of the scheduling information (containing the PT-RS related information (information indicating on which antenna port the PT-RS is mapped)) inputted from the controller 204, the signal demultiplexer 203 demultiplexes the data, the DMRS, and the PT-RS from among the signals inputted from the receiving unit 202. Of the signals thus demultiplexed, the signal demultiplexer 203 outputs the data to the demodulator 207, outputs the DMRS to the channel estimator 205 and the CPE/ICI estimator 206, and outputs the PT-RS to the CPE/ICI estimator 206.

The controller 204 acquires the scheduling information and the quasi-same phase noise group related information from the information contained in the DCI inputted from the signal demultiplexer 203 and/or the information contained in the RRC signal inputted from the error correction coder 208. Further, for example, on the basis of the scheduling information and the quasi-same phase noise group related information, the controller 204 identifies on which antenna port of the base station 100 to map the PT-RS (i.e. from which antenna port the PT-RS has been transmitted). The controller 204 outputs scheduling information containing a result of the identification (PT-RS related information) to the signal demultiplexer 203.

The channel estimator 205 estimates channel information by using the DMRS inputted from the signal demultiplexer 203 and outputs the channel estimation information (channel information) to the demodulator 207.

The CPE/ICI estimator 206 estimates CPE/ICI by using the PT-RS and DMRS inputted from the signal demultiplexer 203 and outputs a CPE/ICI estimate value to the demodulator 207. That is, the CPE/ICI estimator 206 estimates the CPE/ICI of that one of the antenna ports included in the group on which the PT-RS is mapped.

The demodulator 207 demodulates, by using the channel estimation information inputted from the channel estimator 205 and the CPE/ICI estimate value inputted from the CPE/ICI estimator 206, the data signal inputted from the signal demultiplexer 203. The demodulator 207 outputs the demodulated signal to the error correction decoder 208. It should be noted that in demodulating the data signal, the demodulator 207 uses, as a CPE/ICI estimate value for other antenna ports, a CPE/ICI estimate value estimated for a subset of antenna ports by the CPE/ICI estimator 206 within the quasi-same phase noise group.

The error correction decoder 208 decodes the demodulated signal inputted from the demodulator 207 and outputs a received data signal thus obtained. Further, in a case where the RRC signal is contained in the data signal, the error correction decoder 208 outputs the RRC signal to the controller 204.

[Operation of Base Station 100 and Mobile Station 200]

The following describes in detail how the base station 100 and the mobile station 200 operate.

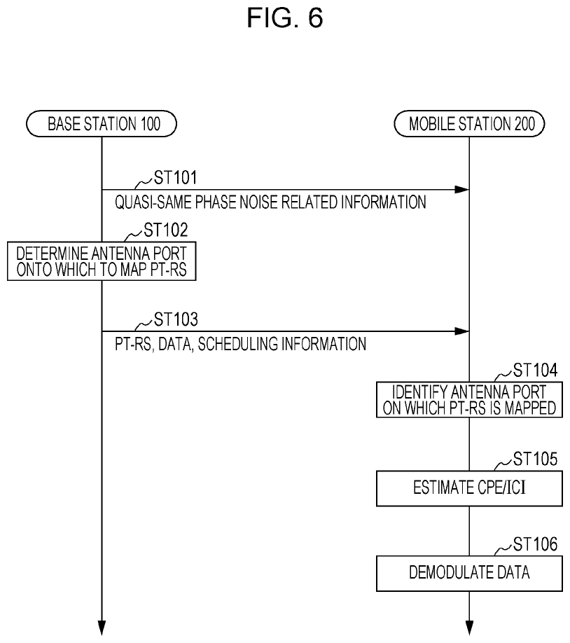

FIG. 6 is a sequence chart showing the flow of processes that are performed by the base station 100 and the mobile station 200.

Note here that CPE/ICI as seen from the mobile station 200 (receiver) may be measured in advance by test equipment or the like (not illustrated) about the influence of phase noise (CPE/ICI) attributed to a local oscillator within the base station 100 (transmitter). Then, on the basis of a result of this measurement (CPE/ICI measured value), a quasi-same phase noise group is determined. That is, a determination is made as to which antenna ports of the antenna 109 of the base station 100 are substantially equal in CPE/ICI as seen from the mobile station 200 (receiver), i.e. which antenna ports belong to the same quasi-same phase noise group. The base station 100 retains quasi-same phase noise group related information, which is information indicating an association between a quasi-same phase noise group and antenna ports that belong to the quasi-same phase noise group.

The base station 100 indicates the quasi-same phase noise group related information to the mobile station 200 by means of DCI, an RRC signal, and/or the like (ST101). For example, the base station 100 may transmit the quasi-same phase noise group related information in the field of the same control signal as a parameter indicating which antenna ports are in a QCL (quasi co-location).

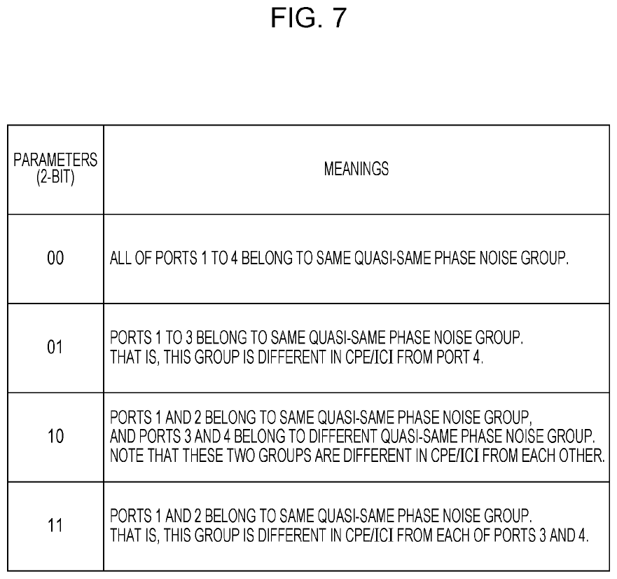

FIG. 7 shows examples of quasi-same phase noise group related information (2-bit parameters) in the case of application of MIMO involving the use of four antenna ports (Ports 1 to 4).

For example, the parameter ‘00’ indicates that all of Ports 1 to 4 are substantially equal in CPE/ICI and that Ports 1 to 4 belong to the same quasi-same phase noise group.

Further, the parameter ‘01’ indicates that Ports 1 to 3 are substantially equal in CPE/ICI and belong to the same quasi-same phase noise group and that Port 4 is different in CPE/ICI from the other antenna ports.

Further, the parameter ‘10’ indicates that Ports 1 and 2 are substantially equal in CPE/ICI and belong to the same quasi-same phase noise group and that Ports 3 and 4 are substantially equal in CPE/ICI and belong to the same quasi-same phase noise group. That is, the parameter ‘10’ indicates that Ports 1 and 2 are different in CPE/ICI from Ports 3 to 4.

Further, the parameter ‘11’ indicates that Ports 1 and 2 are substantially equal in CPE/ICI and belong to the same quasi-same phase noise group, that Ports 1 and 2 are different in CPE/ICI from each of Ports 3 and 4, and that Ports 3 and 4 are different in CPE/ICI from each other.

It should be noted that the parameters shown in FIG. 7 are just examples, and without being limited to the parameters shown in FIG. 7, other parameters may be used.

Next, on the basis of the quasi-same phase noise group related information, the base station 100 determines, from among the antenna ports included in each quasi-same phase noise group, a subset of antenna ports (e.g. one antenna port) onto which to map a PT-RS (ST102).

It should be noted that in a case where there are a plurality of quasi-same phase noise groups, the base station 100 determines one antenna port of each of the groups as an antenna port onto which to map a PT-RS. For example, in the case of the parameter ‘00’ shown in FIG. 7, the base station 100 selects one antenna port from among Ports 1 to 4 as an antenna port onto which to map a PT-RS. Alternatively, in the case of the parameter ‘01’ shown in FIG. 7, the base station 100 selects one antenna port from among Ports 1 to 3 and Port 4 as antenna ports onto which to map a PT-RS. Alternatively, in the case of the parameter ‘10’ shown in FIG. 7, the base station 100 selects one antenna port from among Ports 1 and 2 and one antenna port from among Ports 3 and 4 as antenna ports onto which to map a PT-RS. Alternatively, in the case of the parameter ‘11’ shown in FIG. 7, the base station 100 selects one antenna port from among Ports 1 and 2, Port 3, and Port 4 as antenna ports onto which to map a PT-RS.

Then, the base station 100 maps a PT-RS onto the antenna port determined in ST102 and transmits, to the base station 200, scheduling information containing the PT-RS, data, information (PT-RS related information) on the antenna port on which the PT-RS is mapped (ST103).

On the basis of the quasi-same phase noise group related information received in ST101 and the PT-RS related information received in ST103, the mobile station 200 identifies, from among the antenna ports that belong the same quasi-same phase noise group, an antenna port on which the PT-RS is mapped (ST104).

Then, the mobile station 200 receives the PT-RS transmitted through the antenna port identified in ST104 and estimates CPE/ICI by using the PT-RS thus received (ST105). Further, the mobile station 200 deems that the CPE/ICI of another antenna port that belong to the same quasi-same phase noise group as the antenna port identified in ST104 is equal to the CPE/ICI (CPE/ICI estimate value) estimated for the identified antenna port in ST105.

Then, by using the CPE/ICI estimate value of each antenna port estimated in ST105, the mobile station 200 demodulates the data signal received in ST103 (ST106).

Thus, in the present embodiment, antenna ports of the base station 100 (transmitter) that are substantially equal in CPE/ICI are grouped into the same quasi-same phase noise group. As a result, for example, even antenna ports that use different local oscillators (antenna ports that do not share a local oscillator) are included in the same quasi-same phase noise group, provided the antenna ports are substantially equal in measured CPE/ICI. Alternatively, even antenna ports that use the same different local oscillator (antenna ports that share a local oscillator) are included in different quasi-same phase noise groups, if the antenna ports are different in measured CPE/ICI.

That is, regardless of whether the plurality of antenna ports of the base station 100 share a local oscillator and depending on whether the plurality of antenna ports are equal (quasi-same) in measured value of CPE/ICI actually measured, the plurality of antenna ports are each grouped into a quasi-same phase noise group sharing a PT-RS.

Moreover, the base station 100 maps a PT-RS onto a subset of antenna ports (e.g. one antenna port) of antenna ports each included a quasi-same phase noise and transmits the PT-RS. Further, the mobile station 200 estimates a CPE/ICI estimate value by using a PT-RS transmitted from a subset of antenna ports of antenna ports that belong to a quasi-same phase noise group and uses the CPE/ICI estimate value as a CPE/ICI estimate value of another antenna port that belong to the quasi-same phase noise group.

As noted above, the present embodiment is configured such that for the setting of PT-RS transmissions, a set of antenna ports deemed to be substantially equal in measured value of CPE/ICI is defined as a quasi-same phase noise group without being limited to antenna ports that share a local oscillator of a transmitter or a receiver and one antenna port is set from each quasi-same phase noise group as a PT-RS transmission antenna port.

This allows an antenna port onto which to map a PT-RS to be limited, for example, to one of the antenna ports deemed to be equal in CPE/ICI, thus making it possible to reduce PT-RS overhead. That is, the PT-RS is mapped onto each of the antenna ports deemed to be equal in CPE/ICI, so that wasteful consumption of resources can be prevented. In this way, the present embodiment makes it possible to appropriately determine the number of PT-RS transmission antenna ports and transmit PT-RSs through appropriate antenna ports.

### Embodiment 2

[Brief Overview of Communication System]

The present embodiment describes an uplink PT-RS mapping method.

A communication system according to the present embodiment includes a mobile station 300 (transmitter) and s base station 400 (receiver). For example, the mobile station 300 uses a high frequency band and a high-order modulation multivalued number.

[Configuration of Mobile Station]

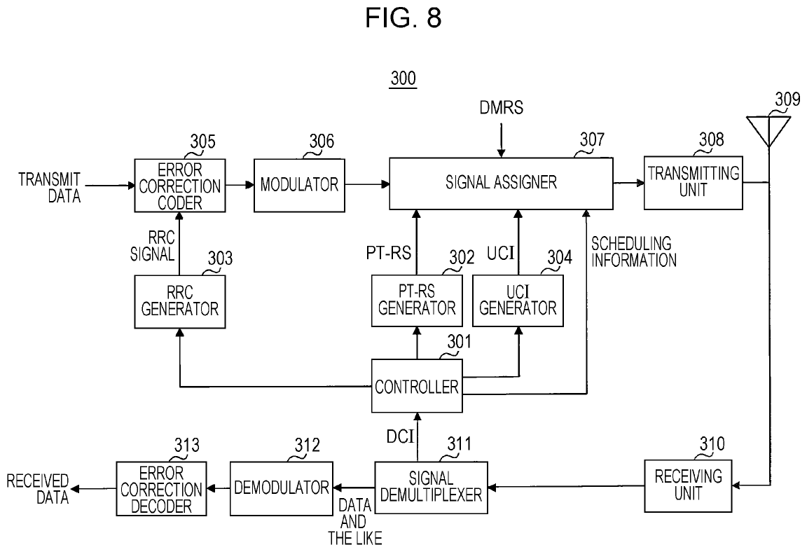

FIG. 8 is a block diagram showing a configuration of the mobile station 300 (transmitter) according to the present embodiment. As shown in FIG. 8, the mobile station 300 includes a controller 301, a PT-RS generator 302, an RRC generator 303, a UCI (uplink control information) generator 304, an error correction coder 305, a modulator 306, a signal assigner 307, a transmitting unit 308, an antenna 309, a receiving unit 310, a signal demultiplexer 311, a demodulator 312, and an error correction decoder 313.

The controller 301 outputs, to the RRC generator 303 and/or the UCI generator 304, information (quasi-same phase noise group related information) indicating which group of antenna ports of the antenna ports for use in transmission and reception is a quasi-same phase noise group.

Further, the controller 301 acquires scheduling information containing a PT-RS on the basis of information (PT-RS related information) contained in DCI inputted from the signal demultiplexer 311 and outputs the scheduling information to the PT-RS generator 302 and the signal assigner 307. That is, the scheduling information is set by the base station 400.

The PT-RS generator 302 generates a PT-RS on the basis of the scheduling information inputted from the controller 301 and outputs the PT-RS thus generated to the signal assigner 307.

Upon receiving the quasi-same phase noise group related information from the controller 301, the RRC generator 303 generates an RRC signal containing the quasi-same phase noise group related information and outputs the RRC signal thus generated to the error correction coder 305.

Upon receiving the quasi-same phase noise group related information from the controller 301, the DCI generator 304 generates UCI containing the quasi-same phase noise group related information and outputs the UCI thus generated to the signal assigner 307.

The error correction coder 305 subjects, to error correction coding, a transmit data signal inputted thereto or an RRC signal inputted thereto from the RRC generator 303 and outputs the signal subjected to the error correction coding to the modulator 306.

The modulator 306 performs a modulation process on the signal inputted from the error correction coder 305 and outputs the data signal thus modulated (which may contain an RRC signal) to the signal assigner 307.

On the basis of the scheduling information inputted from the controller 301, the signal assigner 307 maps a DMRS, the data signal inputted from the modulator 306, and the PT-RS inputted from the PT-RS generator 302 or the UCI inputted from the UCI generator 304 onto time and frequency domains and outputs the signals thus mapped to the transmitting unit 308. In so doing, on the basis of the scheduling information inputted from the controller 301, the signal assigner 307 maps the PT-RS onto one of the antenna ports that belong to the quasi-same phase noise group.

The transmitting unit 308 subjects the signals inputted from the signal assigner 307 to a radio transmission process such as frequency conversion through carrier waves and outputs the signals subjected to the radio transmission process to the antenna 309.

The antenna 309 emits, toward the base station 400, the signals inputted from the transmitting unit 308. Further, the antenna 309 receives a signals transmitted from the base station 400 and outputs the received signals to the receiving unit 310.

The receiving unit 310 subjects the received signals inputted from the antenna 309 to a radio reception process such as frequency conversion and outputs the signals subjected to the radio reception process to the signal demultiplexer 311.

The signal demultiplexer 311 demultiplexes the DCI and the data or the reference signal from among the signals inputted from the receiving unit 310, outputs the DCI to the controller 301, and outputs the data signal or the reference signal to the demodulator 312.

The demodulator 312 demodulates the data signal by using the reference signal inputted from the signal demultiplexer 311. The demodulator 312 outputs the demodulated signal to the error correction decoder 313.

The error correction decoder 313 decodes the demodulated signal inputted from the demodulator 312 and outputs a received data signal thus obtained.

[Configuration of Base Station]

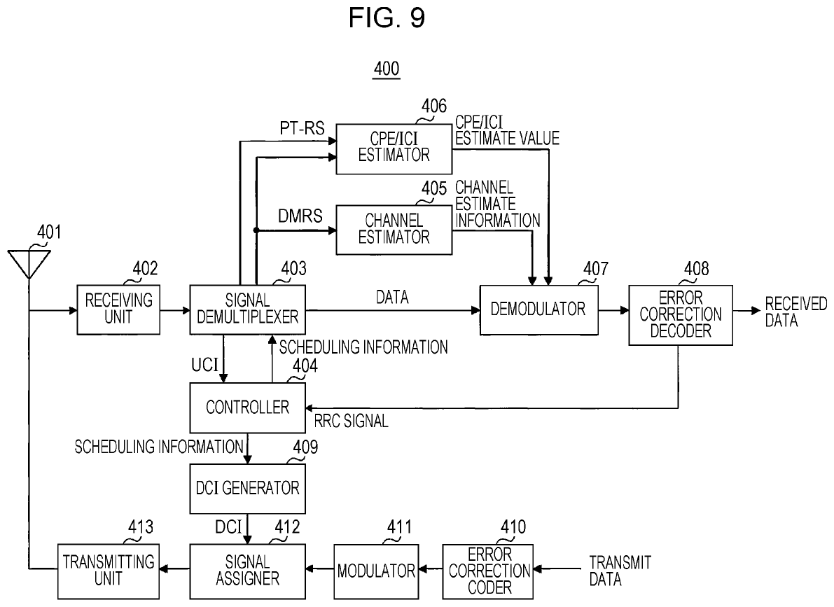

FIG. 9 is a block diagram showing a configuration of the base station 400 (receiver) according to the present embodiment. As shown in FIG. 9, the base station 400 includes an antenna 401, a receiving unit 402, a signal demultiplexer 403, a controller 404, a channel estimator 405, a CPE/ICI estimator 406, a demodulator 407, an error correction decoder 408, a DCI generator 409, an error correction coder 410, a modulator 411, a signal assigner 412, and a transmitting unit 413.

The antenna 401 receives signals transmitted from the mobile station 300 (see FIG. 8) and outputs the received signals to the receiving unit 402. Further, the antenna 401 emits (transmits), toward the mobile station 300, the signals inputted from the transmitting unit 413.

The receiving unit 402 subjects the received signals inputted from the antenna 401 to a radio reception process such as frequency conversion and outputs the signals subjected to the radio reception process to the signal demultiplexer 403.

The signal demultiplexer 403 demultiplexes the UCI from among the signals inputted from the receiving unit 402 first and then outputs the UCI to the controller 404. Then, on the basis of the scheduling information inputted from the controller 404, the signal demultiplexer 403 demultiplexes the data, the DMRS, and the PT-RS from among the signals inputted from the receiving unit 402. Of the signals thus demultiplexed, the signal demultiplexer 403 outputs the data to the demodulator 407, outputs the DMRS to the channel estimator 405 and the CPE/ICI estimator 406, and outputs the PT-RS to the CPE/ICI estimator 406.

The controller 404 acquires the quasi-same phase noise group related information (information indicating which antenna port belongs a quasi-same phase noise group) from the information contained in the UCI inputted from the signal demultiplexer 403 and/or the information contained in the RRC signal inputted from the error correction coder 408. Further, for example, on the basis of the scheduling information and the quasi-same phase noise group related information, the controller 404 determines on which antenna port of the mobile station 300 to map the PT-RS, and outputs scheduling information containing a result of the determination (PT-RS related information) to the signal demultiplexer 403 and the DCI generator 409.

The channel estimator 405 estimates channel information by using the DMRS inputted from the signal demultiplexer 403 and outputs the channel estimation information (channel information) to the demodulator 407.

The CPE/ICI estimator 406 estimates CPE/ICI by using the PT-RS and DMRS inputted from the signal demultiplexer 403 and outputs a CPE/ICI estimate value to the demodulator 407. That is, the CPE/ICI estimator 406 estimates the CPE/ICI of that one of the antenna ports included in the group on which the PT-RS is mapped.

The demodulator 407 demodulates, by using the channel estimation information inputted from the channel estimator 405 and the CPE/ICI estimate value inputted from the CPE/ICI estimator 406, the data signal inputted from the signal demultiplexer 403. The demodulator 407 outputs the demodulated signal to the error correction decoder 408. It should be noted that in demodulating the data signal, the demodulator 407 uses, as a CPE/ICI estimate value for other antenna ports, a CPE/ICI estimate value estimated for a subset of antenna ports by the CPE/ICI estimator 406 within the quasi-same phase noise group.

The error correction decoder 408 decodes the demodulated signal inputted from the demodulator 407 and outputs a received data signal thus obtained. Further, in a case where the RRC signal is contained in the data signal, the error correction decoder 408 outputs the RRC signal to the controller 404.

The DCI generator 409 generates DCI containing the scheduling information (containing the PT-RS related information) inputted from the controller 404 and outputs the DCI thus generated to the signal assigner 412.

The error correction coder 410 subjects, to error correction coding, a transmit data signal inputted thereto and outputs the signal subjected to the error correction coding to the modulator 411.

The modulator 411 performs a modulation process on the signal inputted from the error correction coder 410 and outputs the data signal thus modulated to the signal assigner 412.

The signal assigner 107 maps the signal inputted from the modulator 411 and the DCI inputted from the DCI generator 409 onto time and frequency domains and outputs the signals thus mapped to the transmitting unit 413.

The transmitting unit 413 subjects the signals inputted from the signal assigner 412 to a radio transmission process such as frequency conversion through carrier waves and outputs the signals subjected to the radio transmission process to the antenna 401.

[Operation of Mobile Station 300 and Base Station 400]

The following describes in detail how the mobile station 300 and the base station 400 operate.

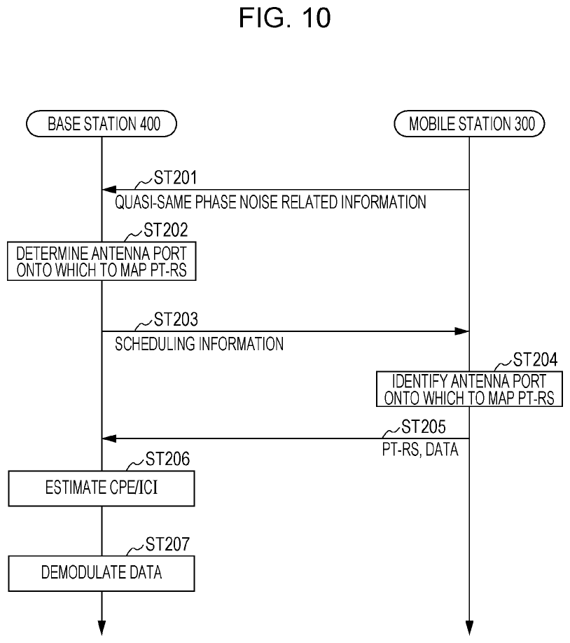

FIG. 10 is a sequence chart showing the flow of processes that are performed by the mobile station 300 and the base station 400.

Note here that as in the case of Embodiment 1, CPE/ICI as seen from the base station 400 (receiver) may be measured in advance by test equipment or the like (not illustrated) about the influence of phase noise (CPE/ICI) attributed to a local oscillator within the mobile station 300 (transmitter). Then, on the basis of a result of this measurement (CPE/ICI measured value), a quasi-same phase noise group is determined. That is, a determination is made as to which antenna ports of the antenna 309 of the mobile station 300 are substantially equal in CPE/ICI as seen from the base station 400 (receiver), i.e. which antenna ports belong to the same quasi-same phase noise group. The mobile station 300 retains quasi-same phase noise group indicating quasi-same phase noise group related information, which is information indicating an association between a quasi-same phase noise group and antenna ports that belong to the quasi-same phase noise group.

The mobile station 300 indicates the quasi-same phase noise group related information to the base station 400 by means of UCI and/or an RRC signal (ST201). For example, as in the case of Embodiment 1, quasi-same phase noise group related information such as that shown in FIG. 7 may be indicated.

Next, on the basis of the quasi-same phase noise group related information indicated in ST201, the base station 400 determines, from among the antenna ports included in each quasi-same phase noise group, a subset of antenna ports (e.g. one antenna port) onto which to a PT-RS is mapped by the mobile station 300 (ST202). It should be noted that in a case where there are a plurality of quasi-same phase noise groups, the base station 400 determines one antenna port of each of the groups as an antenna port onto which to a PT-RS is mapped by the mobile station 300.

Then, the base station 400 transmits, to the mobile station 300, scheduling information (e.g. DCI) containing information (PT-RS related information) indicating the antenna port, determined in ST202, onto which the PT-RS is mapped (ST203).

On the basis of the quasi-same phase noise group related information and the PT-RS related information received in ST203, the mobile station 300 identifies, from among the antenna ports that belong the same quasi-same phase noise group, an antenna port onto which to map the PT-RS (ST204).

Then, the mobile station 300 transmits the data signal and transmits the PT-RS mapped on the antenna port thus identified (ST205).

Then, the base station 400 receives the PT-RS transmitted through the antenna port determined in ST202 and estimates CPE/ICI by using the PT-RS thus received (ST206). Further, the base station 400 deems that the CPE/ICI of another antenna port that belong to the same quasi-same phase noise group as the antenna port determined in ST202 is equal to the CPE/ICI (CPE/ICI estimate value) estimated for the determined antenna port in ST206.

Then, by using the CPE/ICI estimate value of each antenna port estimated in ST206, the base station 400 demodulates the data signal received in ST205 (ST207).

Thus, in the present embodiment, antenna ports of the mobile station 300 (transmitter) that are substantially equal in CPE/ICI are grouped into the same quasi-same phase noise group. As a result, as in the case of Embodiment 1, for example, even antenna ports that use different local oscillators (antenna ports that do not share a local oscillator) are included in the same quasi-same phase noise group, provided the antenna ports are substantially equal in measured CPE/ICI. Alternatively, even antenna ports that use the same different local oscillator (antenna port that share a local oscillator) are included in different quasi-same phase noise groups, if the antenna ports are different in measured CPE/ICI.

That is, regardless of whether the plurality of antenna ports of the mobile station 300 share a local oscillator and depending on whether the plurality of antenna ports are equal (quasi-same) in measured value of CPE/ICI actually measured, the plurality of antenna ports are each grouped into a quasi-same phase noise group sharing a PT-RS.

Moreover, the mobile station 300 maps a PT-RS onto a subset of antenna ports (e.g. one antenna port) of antenna ports each included a quasi-same phase noise and transmits the PT-RS. Further, the base station 400 estimates a CPE/ICI estimate value by using a PT-RS transmitted from a subset of antenna ports of antenna ports that belong to a quasi-same phase noise group and uses the CPE/ICI estimate value as a CPE/ICI estimate value of another antenna port that belong to the quasi-same phase noise group.

As noted above, the present embodiment is configured such that for the setting of PT-RS transmissions, a set of antenna ports deemed to be substantially equal in measured value of CPE/ICI is defined as a quasi-same phase noise group without being limited to antenna ports that share a local oscillator of a transmitter or a receiver and one antenna port is set from each quasi-same phase noise group as a PT-RS transmission antenna port.

As in the case of Embodiment 1, this allows an antenna port onto which to map a PT-RS to be limited, for example, to one of the antenna ports deemed to be equal in CPE/ICI, thus making it possible to reduce PT-RS overhead. That is, the PT-RS is mapped onto each of the antenna ports deemed to be equal in CPE/ICI, so that wasteful consumption of resources can be prevented. In this way, the present embodiment makes it possible to appropriately determine the number of PT-RS transmission antenna ports and transmit PT-RSs through appropriate antenna ports.

The foregoing has described each embodiment of the present disclosure.

### OTHER EMBODIMENTS

(1) The foregoing embodiments have described a case where an antenna port in a quasi-same phase noise group onto which a PT-RS is mapped is explicitly indicated from the base station to the mobile station (e.g. ST103 of FIG. 6 or ST203 of FIG. 10). However, as an antenna port onto which a PT-RS is mapped, at least one antenna port within a quasi-same phase noise group may be fixedly defined. Alternatively, an antenna port in a quasi-same phase noise group onto which a PT-RS is mapped may be implicitly indicated in association with another parameter that is indicated from the base station to the mobile station.

For example, the transmitter (i.e. the base station 100 or the mobile station 300) may map a PT-RS onto that one of the antenna ports within a quasi-same phase noise group which has a predetermined index (e.g. an antenna port with the lowest (or highest) antenna port number). Similarly, the receiver (i.e. the mobile station 200 or the base station 400) may determine that a PT-RS is mapped on that one of the antenna ports within a quasi-same phase noise group which has a predetermined index defined between the receiver and the transmitter. This eliminates the need to indicate, from the base station to the mobile station, information indicating on which antenna port a PT-RS is actually mapped, and makes it possible to reduce signaling.

Alternatively, for the plurality of antenna ports of the transmitter (i.e. the base station 100 or the mobile station 300), a combination of the number of antenna ports that belong to each quasi-same phase noise group and the indices (antenna port numbers) of antenna ports that belong to a quasi-same phase noise group including the number of antenna ports may be fixedly defined.

For example, one pattern of combination of the number of antenna ports that belong to each quasi-same phase noise group and the indices of antenna ports that belong to a quasi-same phase noise group including the number of antenna ports may be defined. For example, a case is described where the transmitter includes four antenna ports (Ports 1 to 4). In a case where all of Ports 1 to 4 belong to the same quasi-same phase noise group, one pattern is defined as a combination of the indices of the antenna ports that belong to this group. Similarly, in a case where there exist a quasi-same phase noise (called “first group”) to which three of Ports 1 to 4 belong and a quasi-same phase noise group (called “second group”) to which one of Ports 1 to 4 belongs, one pattern is defined as a combination of the indices of the antenna ports that belong to the first group and the index of the antenna port that belongs to the second group. The same applies to the indices of antenna patterns in a quasi-same phase noise group including another number of antennas.

Further, in so doing, for example, lower (or higher) indices (antenna port numbers) may be assigned in descending order of the numbers of antenna ports of quasi-same phase noise groups to which antenna ports belong.

This allows the receiver (i.e. the mobile station 200 or the base station 400) to, with respect to an antenna port configuration of each quasi-same phase noise group indicated by quasi-same phase noise group related information indicated from the transmitter, uniquely identify antenna ports (indices) that belong to each quasi-same phase noise group. Further, making, for example, one pattern of candidates for antenna ports (indices) in a quasi-same phase noise group including a certain number of antenna ports eliminates the need to indicate a plurality of combinations of antenna ports for a quasi-same phase noise group including the same number of antenna ports. This makes it possible to prevent an increase in the amount of signaling (number of bits) for indicating quasi-same phase noise group related information. It should be noted that there may be not only one pattern but also two or more patterns of combination of antenna ports for a quasi-same phase noise group including the same number of antenna ports.

Further, with this, in Embodiment 1 (see, for example, FIG. 6), the mobile station 200 can identify, by means of the indication of ST103 without the need for the indication of ST101, antenna ports (indices) that belong to each quasi-same phase noise group. Furthermore, in a case where the mobile station 200 can identify an antenna port within each group onto which a PT-RS is mapped, the base station 100 does not need to indicate quasi-same phase noise group related information in ST101.

For example, a case is described where the transmitter includes four antenna ports (Ports 1 to 4). In ST103, the base station 100 indicates to the mobile station 200 that the lowest indices of the antenna ports (indices) that belong to each quasi-same phase noise group are “1 and 4”. At this point of time, the mobile station 200 can determine that there exist a quasi-same phase noise group to which Ports 1 to 3 belong and a quasi-same phase noise group to which Port 4 belongs. In this case, quasi-same phase noise group related information does not need to be indicated to the mobile station 200 in ST101 (that is, the base station 100 does not need to perform the indication of ST101).

(2) In the foregoing embodiments, the indication in ST101 or ST201 of antenna ports that belong to a quasi-same phase noise group (see, for example, FIG. 7) and the explicit/implicit indication in ST103 or ST203 of an antenna port onto which to map a PT-RS may involve the use of the port number of a different reference signal (e.g. a DMRS, a channel state information reference signal (CSI-RS), a sounding reference signal (SRS), a time-frequency tracking reference signal (TRS: tracking reference signal)) or a synchronization signal (SS). Further, the determination in ST102 or ST202 of an antenna port onto which to map a PT-RS may involve the use of the port number of the different reference signal.

For example, a case is described where in an uplink, the transmitter (mobile station 300) includes four antenna ports. In ST201, the mobile station 300 may indicate information to the base station 400 to the effect that “the antenna ports corresponding to SRS ports 0 and 2 belong to the same quasi-same phase noise group, and the antenna ports corresponding to SRS ports 1 and 3 belong to another quasi-same phase noise group”. Further, in ST202, the base station 400 may determine that “a PT-RS is mapped onto each of the antenna ports corresponding to SRS ports 0 and 1” and, in ST203, explicitly/implicitly indicate this information to the mobile station 300.

(3) Although the foregoing embodiments have described a case where a PT-RS is mapped onto one of the antenna ports included in a quasi-same phase noise group, the number of antenna ports in a quasi-same phase noise group onto which a PT-RS is mapped is not limited to one. A PT-RS may be mapped onto two or more antenna ports.

(4) The term “CPE/ICI correction” used in the embodiments described above means “correcting a CPE”, “correcting ICI”, or “correcting both a CPE and ICI”.

(5) The term “quasi-same phase noise group” used in the foregoing embodiments does not need to be called by this name but may be called by another name (for example, simply “quasi-same phase noise”).

(6) A signal transmitted from each antenna port within a set of antenna ports belonging to a “quasi-same phase noise group” may be frequency-converted by the same or different local oscillators at the transmitter. Similarly, which antenna port belongs to a “quasi-same phase noise group” may depend on the circuit configuration of a transmitting unit mounted in each base station or mobile station or the performance or number of local oscillators within the circuit configuration of a transmitting unit.

(7) In the foregoing embodiments, for example, in a case where the circuit configurations of transmitting units in individual base stations or mobile stations or the performance or number of local oscillators within the circuit configuration of a transmitting unit can be deemed to be the same as in the case of products of the same product number, the individual base stations or mobile stations may be deemed to the same as to “which antenna port belongs to a ‘quasi-same phase noise group’”. Furthermore, in this case, a measurement or a test is performed on one individual base station or mobile station about a “quasi-same phase noise group”, and a result of the measurement or the test may be deemed to be the same for all of the other individual base stations or mobile stations as to “which antenna port belongs to a ‘quasi-same phase noise group’”.

(8) The foregoing embodiments assume that different densities of allocation of PT-RSs and different numbers of antenna ports to which PT-RSs are assigned are set for each separate mobile station. Accordingly, in a downlink, information on antenna ports belonging to a “quasi-same phase noise group” may be uniquely (UE-specifically) indicated from the base station to each mobile station. Meanwhile, in an uplink, too, information on antenna ports belonging to a “quasi-same phase noise group” may be uniquely indicated from each mobile station to the base station.

(9) Further, although the embodiment (FIG. 1) described above assumes that the length of a slot is 14 symbols, the length of a slot is not limited to 14 symbols. For example, the length of a slot may be 7 symbols or another number of symbols.

(10) Further, in the case of frequency multiplexing of control channels (PDCCH (Physical Downlink Control Channel) and PUCCH (Physical Uplink Control Channel)) and data channels (PDSCH (Physical Downlink Shared Channel) and PUSCH (Physical Uplink Shared Channel)), PT-RSs may be mapped onto their symbols.

(11) Further, the present disclosure may be achieved with software, hardware, or software in cooperation with hardware. Each of the functional blocks used to describe the embodiments above may be partly or wholly achieved as an LSI, which is an integrated circuit, and each of the processes described in the embodiments above may be partly or wholly controlled by a single LSI or a combination of LSIs. The LSIs may each be composed of individual chips, or may be composed of a single chip so as to include some or all of the functional blocks. The LSIs may each include an input and an output for data. Depending on the degree of integration, the LSIs may alternatively be referred to as “ICs”, “system LSIs”, “super LSIs”, or “ultra LSIs”. However, the technique of implementing an integrated circuit is not limited to LSI and may be achieved by using a dedicated circuit, a general-purpose processor, or a dedicated processor. In addition, an FPGA (field-programmable gate array) that can be programmed after the manufacture of an LSI or a reconfigurable processor in which the connections and the settings of circuit cells disposed inside an LSI can be reconfigured may be used. The present disclosure may be achieved as digital processing or analog processing. If future integrated circuit technology replaces LSI as a result of the advancement of semiconductor technology or other derivative technology, the functional blocks could be integrated using the future integrated circuit technology. For example, biotechnology can also be applied.

A transmitter of the present disclosure includes: an assignment circuit that maps a phase tracking reference signal onto a subset of antenna ports of antenna ports each included in at least one group into which a plurality of antenna ports have been grouped, the group being determined on the basis of a measured value of phase noise measured for each of the plurality of antenna ports; and a transmitting circuit that transmits a data signal and the phase tracking reference signal.

In the transmitter of the present disclosure, those ones of the plurality of antenna ports which are equal in the measured value belong to an identical one of the at least one group and those ones of the plurality of antenna ports which are different in the measured value belong to different ones of the at least one group, respectively.

In the transmitter of the present disclosure, the transmitting circuit further transmits information indicating an association between the group and the antenna ports that belong to the group.

A receiver of the present disclosure includes: a receiving circuit that receives a data signal and a phase tracking reference signal transmitted from a subset of antenna ports of antenna ports each included in at least one group into which a plurality of antenna ports of a transmitter have been grouped, the group being determined on the basis of a measured value of phase noise measured for each of the plurality of antenna ports; and a demodulating circuit that demodulates the data signal by using a phase noise estimate value estimated from the phase tracking reference signal. The demodulating circuit uses, as a phase noise estimate value for other antenna ports included in the group excluding the subset of antenna ports, the phase noise estimate value for the subset of antenna ports.

A transmission method of the present disclosure includes: mapping a phase tracking reference signal onto a subset of antenna ports of antenna ports each included in at least one group into which a plurality of antenna ports have been grouped, the group being determined on the basis of a measured value of phase noise measured for each of the plurality of antenna ports; and transmitting a data signal and the phase tracking reference signal.

A reception method of the present disclosure includes: receiving a data signal and a phase tracking reference signal transmitted from a subset of antenna ports of antenna ports each included in at least one group into which a plurality of antenna ports of a transmitter have been grouped, the group being determined on the basis of a measured value of phase noise measured for each of the plurality of antenna ports; and demodulating the data signal by using a phase noise estimate value estimated from the phase tracking reference signal. In demodulating the data signal, the phase noise estimate value for the subset of antenna ports is used as a phase noise estimate value for other antenna ports included in the group excluding the subset of antenna ports.

A communication method of the present disclosure includes: measuring a measured value of phase noise for each of a plurality of antenna ports of a transmitter; grouping the plurality of antenna ports into at least one group on the basis of the measured value of phase noise; mapping a phase tracking reference signal onto a subset of antenna ports of antenna ports each included in the at least one group; transmitting a data signal and the phase tracking reference signal; receiving the data signal and the phase tracking reference signal transmitted from the subset of antenna ports included in the group; and demodulating the data signal by using a phase noise estimate value estimated from the phase tracking reference signal. In demodulating the data signal, the phase noise estimate value for the subset of antenna ports is used as a phase noise estimate value for other antenna ports included in the group excluding the subset of antenna ports.

An embodiment of the present disclosure is useful to a mobile communication system.

### REFERENCE SIGNS LIST

100, 400 Base station
101, 204, 301, 404 Controller
102, 302 PT-RS generator
103, 303 RRC generator
104, 409 DCI generator
105, 305, 410 Error correction coder
106, 306, 411 Modulator
107, 307, 412 Signal assigner
108, 308, 413 Transmitting unit
109, 201, 309, 401 Antenna
200, 300 Mobile station
202, 310, 402 Receiving unit
203, 311, 403 Signal demultiplexer
205, 405 Channel estimator
206, 406 CPE/ICI estimator
207, 312, 407 Demodulator
208, 313, 408 Error correction decoder
304 UCI generator

1. A transmitter comprising:
an assignment circuit, which, in operation, maps a phase tracking reference signal onto a subset of antenna ports of antenna ports each included in at least one group into which a plurality of antenna ports have been grouped, the group being determined on the basis of a measured value of phase noise measured for each of the plurality of antenna ports; and
a transmitting circuit, which, in operation, transmits a data signal and the phase tracking reference signal.

2. The transmitter according to claim 1, wherein those ones of the plurality of antenna ports which are equal in the measured value belong to an identical one of the at least one group and those ones of the plurality of antenna ports which are different in the measured value belong to different ones of the at least one group, respectively.

3. The transmitter according to claim 1, wherein the transmitting circuit, in operation, further transmits information indicating an association between the group and the antenna ports that belong to the group.

4. A receiver comprising:
a receiving circuit, which, in operation, receives a data signal and a phase tracking reference signal transmitted from a subset of antenna ports of antenna ports each included in at least one group into which a plurality of antenna ports of a transmitter have been grouped, the group being determined on the basis of a measured value of phase noise measured for each of the plurality of antenna ports; and
a demodulating circuit, which, in operation, demodulates the data signal by using a phase noise estimate value estimated from the phase tracking reference signal,
wherein the demodulating circuit, in operation, uses, as a phase noise estimate value for other antenna ports included in the group excluding the subset of antenna ports, the phase noise estimate value for the subset of antenna ports.

5. A transmission method comprising:
mapping a phase tracking reference signal onto a subset of antenna ports of antenna ports each included in at least one group into which a plurality of antenna ports have been grouped, the group being determined on the basis of a measured value of phase noise measured for each of the plurality of antenna ports; and
transmitting a data signal and the phase tracking reference signal.

6. A reception method comprising:
receiving a data signal and a phase tracking reference signal transmitted from a subset of antenna ports of antenna ports each included in at least one group into which a plurality of antenna ports of a transmitter have been grouped, the group being determined on the basis of a measured value of phase noise measured for each of the plurality of antenna ports; and
demodulating the data signal by using a phase noise estimate value estimated from the phase tracking reference signal,
wherein in demodulating the data signal, the phase noise estimate value for the subset of antenna ports is used as a phase noise estimate value for other antenna ports included in the group excluding the subset of antenna ports.

7. A communication method comprising:
measuring a measured value of phase noise for each of a plurality of antenna ports of a transmitter;
grouping the plurality of antenna ports into at least one group on the basis of the measured value of phase noise;
mapping a phase tracking reference signal onto a subset of antenna ports of antenna ports each included in the at least one group;
transmitting a data signal and the phase tracking reference signal;
receiving the data signal and the phase tracking reference signal transmitted from the subset of antenna ports included in the group; and
demodulating the data signal by using a phase noise estimate value estimated from the phase tracking reference signal,
wherein in demodulating the data signal, the phase noise estimate value for the subset of antenna ports is used as a phase noise estimate value for other antenna ports included in the group excluding the subset of antenna ports.
